(19) United States
(12) Patent Application Publication
(10) Pub. No.: US 2017/0100681 A1
(43) Pub. Date: Apr. 13, 2017

(54) PLASMA GAS WATER IONIZATION PURIFICATION SYSTEM

(71) Applicant: Clyde A. Livingston, Stockton, CA (US)

(72) Inventor: Clyde A. Livingston, Stockton, CA (US)

(21) Appl. No.: 15/285,460

(22) Filed: Oct. 4, 2016

Related U.S. Application Data
(60) Provisional application No. 62/238,307, filed on Oct. 7, 2015.

(51) Int. Cl. B01D 1/00; C02F 1/04; H05H 1/34; B01D 1/30

(52) U.S. Cl. CPC B01D 1/0017; B01D 1/30; C02F 1/04; H05H 1/3405

(57) ABSTRACT

A plasma gas water ionization purification system that purifies waste water into clean water by removing inert waste solids from the waste water. The plasma gas water ionization purification system includes an ionization chamber and a plasma emitting device. The ionization chamber receives the waste water. The plasma emitting device is operatively connected to the ionization chamber and generates a stream of plasma to heat the waste water in the ionization chamber to generate purified steam from the waste water, thereby resulting in separation of the purified steam from the inert waste solids in the waste water, with the purified steam then being condensed into liquid form forming the clean water, which is collected for later use.

### CROSS REFERENCE TO RELATED APPLICATIONS

The instant non-provisional patent application claims priority from provisional patent application No. 62/238,307, filed on Oct. 7, 2015, for a PLASMA GAS WATER IONIZATION PURIFICATION SYSTEM, and incorporated herein in its entirety by reference thereto.

### BACKGROUND OF THE INVENTION

Field of the Invention

The embodiments of the present invention relate to a plasma gas water ionization system, and more particularly, the embodiments of the present invention relate to a plasma gas water ionization purification system.

Description of the Prior Art

Many current water purification systems are high in maintenance and are very costly to operate. Additionally, many current waste water treatment systems utilize chemicals, such as, chlorine and sulfuric acid. Such chemicals—when exposed to the environment—may have detrimental effects that can cost millions of dollars to clean and decontaminate. Further, because of the negative effects that these chemicals may have on the environment, these systems require very strict oversight and maintenance, which can also be costly. Therefore, there is an apparent need for a water purification system that is both environmentally friendly and cost effective.

Numerous innovations for water purification systems have been provided in the prior art, which will be described below in chronological order to show advancement in the art, and which are incorporated herein in their entirety by reference thereto. Even though these innovations may be suitable for the specific individual purposes to which they address, nevertheless, they differ from the embodiments of the present invention.

### U.S. Pat. No. 3,933,606 to Harms

U.S. Pat. No. 3,933,606—issued to Harms on Jan. 20, 1976 in US class 205 and subclass 743—teaches a process and apparatus for electrolytically removing suspended and dissolved impurities from contaminated water. By the process, contaminated water is fed to a column where it is exposed to an electrical field created between a plurality of oppositely charged perforate plates by a pulsating electrical signal. The pulsating signal causes cations to be freed from the plates and destroy bacteria and cyanide where present. The process causes a micro-floc to form, which grows by a chaining process into a large and easily separable floc that adsorbs essentially all of the suspended matter in the contaminated water including soil and other particles of colloidal size, dead bacteria, and precipitated metal salts, as well as some metal ions.

### U.S. Pat. No. 5,531,865 to Cole

U.S. Pat. No. 5,531,865—issued to Cole on Jul. 2, 1996 in US class 205 and subclass 751—teaches a method for removing contaminants from a flow of waste water using an electrolytic oxidation vessel having a chamber and at least one elongate cathode electrode and a plurality of elongate sacrificial anode electrodes aligned parallel with the cathode electrode in the chamber. The flow of waste water is directed through the chamber of the electrolytic oxidation vessel, in a direction parallel with the cathode and the anode electrodes, so that the flow of the waste water engages the cathode and the anode electrodes. A voltage is applied across the cathode electrode and the sacrificial anode electrodes to create a current having a density ranging from approximately 5-7 ma/cm² so as to release ions from the anode electrodes, which oxidize and render insoluble contaminants in the flow of the waste water and create insoluble contaminants and substantially cleansed water. The insoluble contaminants are separated from the substantially cleansed water. An apparatus for use with the method is also taught.

### U.S. Pat. No. 5,531,865 to Cole

U.S. Pat. No. 5,531,865—issued to Cole on Jul. 2, 1996 in US class 205 and subclass 751—teaches a method for removing contaminants from a flow of waste water using an electrolytic oxidation vessel having a chamber and at least one elongate cathode electrode and a plurality of elongate sacrificial anode electrodes aligned parallel with the cathode electrode in the chamber. The flow of waste water is directed through the chamber of the electrolytic oxidation vessel in a direction parallel to the cathode and anode electrodes, so that the flow of the waste water engages the cathode and anode electrodes. A voltage is applied across the cathode electrode and the sacrificial anode electrodes to create a current having a density ranging from approximately 5-7 ma/cm² so as to release ions from the anode electrodes, which oxidize and render insoluble contaminants in the flow of the waste water and create insoluble contaminants and substantially cleansed water. The insoluble contaminants are separated from the substantially cleansed water. An apparatus for use with the method is also taught.

### United States Patent Application Publication Number US 2003/0106854 A1 to Robinson

United States Patent Application Publication Number US 2003/0106854 A1—published to Robinson on Jun. 12, 2003 in US class 210 and subclass 748.18—teaches a water treatment involving delivering an instantaneous electric current to one or more pairs of activated electrodes immersed in the water. Each of the pairs of electrodes include a sacrificial electrode operating predominantly as an anode and an inert electrode operating predominantly as a cathode. The sacrificial electrode, when operating as an anode, is able to provide dissolved ions to the water as current passes between the pairs of electrodes to assist in treating the water. The polarity of the electrodes is periodically reversed to reduce electrode clogging. The amount of charge passed by the instantaneous electric current is indicative of the degree to which the water has been treated and is used to control the treatment process.

### United States Patent Application Publication Number US 2004/0084382 A1 to Rvazanova et al

United States Patent Application Publication Number US 2004/0084382 A1—published to Ryazanova et al. on May 6, 2004 in US class 210 and subclass 748.11—teaches a system and method for purification and disinfection of water containing contaminates. The system includes an aeration column, a first intermediate tank, a first mechanical filter, an electric discharge device, a second intermediate tank, a second mechanical filter, and a sorption filter. The water is firstly aerated by continuous mixing the water with air and an ozone-air mixture. The water obtained after the aeration is treated with coagulant materials in a medium of the ozone-air mixture. Further, the water is filtered from coagulated particles. Thereafter, the water is treated by electric discharges in an air medium. The water is then treated again with coagulant materials. Finally, the water is filtered from remaining contaminates.

### U.S. Pat. No. 6,887,368 B2 to Khalemsky et al

U.S. Pat. No. 6,887,368 B2—issued to Khalemsky et al. on May 3, 2005 in US class 205 and subclass 702—teaches a method for heavy metals electro-extraction from technological solutions and waste water. The method includes pre-treating to remove Chromium-6 and high concentrations of heavy metals and periodically treating in a six-electrode bipolar cylindrical electro-reactor made of non-conducting material to achieve lower accepted levels of impurities. Six cylindrical steel electrodes form two triode stacks and are fed with three-phase alternating current of commercial frequency (50-60 Hz), which can be pulsed. Each phase of the three-phase current is connected to three electrodes of one triode stack or in parallel to two triode stacks. The parallel connection of the three-phase current to the two triode stacks is performed so that the same phase of the three phase current is connected in parallel with each two opposite electrodes of the six electrodes located along the periphery, or with two adjacent electrodes. A bipolar stationary aluminum electrode is situated in the inter-electrode space. In one of the embodiments, the bipolar electrode is made of a perforated, heat-resistant, and plastic container filled with secondary aluminum and Duralumin scrap. In another embodiment, the bipolar electrode of aluminum or the Duralumin scrap may be made without a perforated container and is placed in the inter-electrode space as a bulk scrap. In this case, to prevent shorts, each of the six steel electrodes is placed in an isolated, perforated, and plastic shell with holes of 5 mm in diameter. Non-ferrous metals are extracted in a form of ferrite-chromites, and aluminates as well as hydroxyl salts deposited in the inter-electrode space without electrolysis deposits on electrodes. Deposits are separated from solution by known methods of filtration.

### United States Patent Application Publication Number US 2009/0321251 A1 Published to Rigby

United States Patent Application Publication Number US 2009/0321251 A1—published to Rigby on Dec. 31, 2009 in US class 204 and subclass 229.6—teaches removing contaminants from raw water or discharge water from plants, such as, sewerage and industrial plants, by applying direct current through an array of spaced and alternately charged electrodes to eliminate or minimize clogging of the electrodes with precipitated contaminants. Polarity may be switched periodically to assist in eliminating or minimizing clogging. In illustrated embodiments, electrode arrays are contained in housings of dielectric material to form modules. To increase processing capacity, the modules are arranged in parallel arrays. Alternatively, a single module is scaled up for large or industrial applications or scaled down for personal use. Instead of housing the electrode arrays in modules through which liquid passes, the electrode arrays for some batch applications are dipped in the water or aqueous solutions.

### U.S. Pat. No. 7,914,662 B2 to Robinson

U.S. Pat. No. 7,914,662 B2—issued to Robinson on Mar. 29, 2011 in US class 205 and subclass 745—teaches a portable apparatus for treating polluted water by electro-coagulation. The apparatus includes at least two electrodes. The apparatus also includes a housing, electrically isolated from the at least two electrodes, to which the at least two electrodes are fixed spaced-apart from one another. When the at least two second electrodes are at least partly submerged in the polluted water and provided with an electrical potential, one of the at least two electrodes is sacrificial so as to provide ions to the polluted water.

It is apparent that numerous innovations for water purification systems have been provided in the prior art, which are adapted to be used. Furthermore, even though these innovations may be suitable for the specific individual purposes to which they address, nevertheless, they would not be suitable for the purposes of the embodiments of the present invention as heretofore described.

### SUMMARY OF THE INVENTION

Thus, an object of the embodiments of the present invention is to provide a plasma gas water ionization purification system, which avoids the disadvantages of the prior art.

Briefly stated, another object of the embodiments of the present invention is to provide a plasma gas water ionization purification system that purifies waste water into clean water by removing inert waste solids from the waste water. The plasma gas water ionization purification system includes an ionization chamber and a plasma emitting device. The ionization chamber receives the waste water. The plasma emitting device is operatively connected to the ionization chamber and generates a stream of plasma to heat the waste water in the ionization chamber to generate purified steam from the waste water, thereby resulting in separation of the purified steam from the inert waste solids in the waste water, with the purified steam then being condensed into liquid form forming the clean water, which is collected for later use.

The novel features considered characteristic of the embodiments of the present invention are set forth in the appended claims. The embodiments of the present invention themselves, however, both as to their construction and to their method of operation together with additional objects and advantages thereof will be best understood from the following description of the embodiments of the present invention when read and understood in connection with the accompanying figures of the drawing.

### BRIEF DESCRIPTION OF THE FIGURES OF THE DRAWING

The figures of the drawing are briefly described as follows:

FIG. 1 is a diagrammatic perspective view of the plasma gas water ionization purification system of the embodiments of the present invention;

FIG. 2 is a diagrammatic front elevational view taken in the direction of ARROW 2 in FIG. 1;

FIG. 3 is a diagrammatic rear elevational view taken in the direction of ARROW 3 in FIG. 1;

FIG. 4 is a diagrammatic right side elevational view taken in the direction of ARROW 4 in FIG. 1;

FIG. 5 is a diagrammatic left side elevational view taken in the direction of ARROW 5 in FIG. 1;

FIG. 6 is a diagrammatic top plan view taken in the direction of ARROW 6 in FIG. 1;

FIG. 7 is a diagrammatic bottom plan view taken in the direction of ARROW 7 in FIG. 1;

FIG. 8 is an exploded diagrammatic perspective view of the plasma gas water ionization purification system of the embodiments of the present invention shown in FIG. 1;

FIG. 9 is a diagrammatic cross sectional view taken along LINE 9-9 in FIG. 1;

FIG. 10 is an enlarged diagrammatic perspective view of the area generally enclosed by the dotted curve identified by ARROW 10 in FIG. 8 of an embodiment of the plasma emitting device of the plasma gas water ionization purification system of the embodiments of the present invention;

FIG. 11 is a diagrammatic cross sectional view taken along LINE 11-11 in FIG. 10;

FIG. 12 is an enlarged diagrammatic perspective view of the area generally enclosed by the dotted curve identified by ARROW 12 in FIG. 8 of an alternate embodiment of the plasma emitting device of the plasma gas water ionization purification system of the embodiments of the present invention;

FIG. 13 is a diagrammatic cross sectional view taken along LINE 13-13 in FIG. 12;

FIG. 14 is an enlarged diagrammatic top plan view of a typical clamp bracket of the plasma emitting device identified by ARROW 14 in FIG. 1; and

FIG. 15 is a diagrammatic side elevational view taken generally in the direction of ARROW 15 in FIG. 14.

### LIST OF REFERENCE NUMERALS UTILIZED IN THE FIGURES OF THE DRAWING

### Introductory

20 plasma gas water ionization purification system of embodiments of present invention for purifying waste water 22 into clean water 24 by removing inert waste solids 26 from waste water 22
22 waste water
24 clean water
26 inert waste solids from waste water 22

### Overall Configuration of Plasma Gas Water Ionization Purification System 20

28 ionization chamber for receiving waste water 22
30 plasma emitting device 30 for generating stream of plasma to heat waste water 22 in ionization chamber 28 to generate purified steam 32 from waste water 22, thereby resulting in separation of purified steam 32 from inert waste solids 26 in waste water 22, with purified steam 32 then being condensed into liquid form forming clean water 24, which is collected for later use
32 purified steam
34 collection chamber for condensing purified steam 32 into clean water 24 and for collecting clean water 24
36 waste chamber for collecting inert waste solids 26 removed from waste water 22
38 waste conduit for communicating inert waste solids 26 in ionization chamber 28 to waste chamber 36
40 vapor conduit for fluidly communicating purified steam 32 in ionization chamber 28 to collection chamber 34
42 input conduit for fluidly directing waste water 22 into ionization chamber 28

### Specific Configuration of Waste Chamber 36

43 non-flammable and heat-resistant insulation of waste chamber 36
44 support surface for having waste chamber 36 rest thereon
46 hollow interior of waste chamber 36
48 top of waste chamber 36
50 opening of top 48 of waste chamber 36
50a hatch of waste chamber 36

### Specific Configuration of Waste Conduit 38

51 top of waste conduit 38
52 opening of top 51 of waste conduit 38
54 bottom of waste conduit 38
56 opening of bottom 54 of waste conduit 38
57 non-flammable and heat-resistant insulation of waste conduit 38
58 hollow interior of waste conduit 38
59 maintenance hatch of waste conduit 38

### Specific Configuration of Ionization Chamber 28

59a non-flammable and heat-resistant insulation of ionization chamber 28
60 top of ionization chamber 28
62 input opening of top 60 of ionization chamber 28
64 vapor opening of top 60 of ionization chamber 28
65 view portal of ionization chamber 28
66 bottom of ionization chamber 28
68 waste opening of bottom 66 of ionization chamber 28
69 maintenance hatch of ionization chamber 28
70 hollow interior of ionization chamber 28
71 drain plug of ionization chamber 28
72 trap doors on bottom 66 of ionization chamber 28 for selectively allowing inert waste solids 26 in ionization chamber 28 to be directed into waste conduit 38 and then into waste chamber 36 via gravity
74 plurality of plasma device openings of top 60 of ionization chamber 28

### Specific Configuration of Vapor Conduit 40

76 top of vapor conduit 40
78 opening of top 76 of vapor conduit 40
80 bottom of vapor conduit 40
82 opening of bottom 80 of vapor conduit 40
84 hollow interior of vapor conduit 40
86 walls of vapor conduit 40

### Specific Configuration of Input Conduit 42

88 top of input conduit 42 for allowing waste water 22 to enter therein
90 opening of top 88 of input conduit 42
92 bottom of input conduit 42
94 opening of bottom 92 of input conduit 42
96 hollow interior of input conduit 42

### Specific Configuration of Collection Chamber 34

98 input end of collection chamber 34
100 opening of input end 98 of collection chamber 34
102 collection end of collection chamber 34
104 hollow interior of collection chamber 34
106 ceiling of collection chamber 34
108 inner surface of ceiling 106 of collection chamber 34
110 fan of collection chamber 34 for expeditiously moving clean water being condensed 24 through collection chamber 34, while adding element of coolness for further facilitating condensing clean water 24
112 axle of collection chamber 34

### Overall Configuration of Plasma Emitting Device 30

114 head of plasma emitting device 30 for heating waste water 22
116 tail of plasma emitting device 30 for receiving inert gas 118 and feeding inert gas 118 to head 114 of plasma emitting device 30
118 inert gas

### Specific Configuration of First Embodiment of Plasma Emitting Device 120

120 plasma emitting device
121 shell of ignition device 122 of plasma emitting device 120
122 ignition device for producing stream of plasma via ionization of inert gas 130
123 base of shell 121 of plasma emitting device 120
124 plurality of pipes for injecting inert gas 130 into ignition device 122 of plasma emitting device 120 for ionization and thus plasma ignition
130 inert gas of gas source 132
132 gas source
133 plurality of clamp brackets of plasma emitting device 30
134 storage tank of gas source 132 of plasma emitting device 120
136 direct line of gas source 132 of plasma emitting device 120 for supplying and forcing inert gas 130 into plurality of pipes 124 of plasma emitting device 120
138 plurality of electrode torches of ignition device 122 of plasma emitting device 120
140 plurality of gas channels of ignition device 122 of plasma emitting device 120 for receiving inert gas 130
142 plurality of nozzles of ignition device 122 of plasma emitting device 120 for maintaining electric arc between plurality of electrode torches 138 of ignition device 122 of plasma emitting device 120
144 cathodes of ignition device 122 of plasma emitting device 120
146 anodes of ignition device 122 of plasma emitting device 120
148 circular pipe of plurality of gas channels 140 of ignition device 122 of plasma emitting device 120

### Specific Configuration of Second Embodiment of Plasma Emitting Device 150

150 plasma emitting device
152 ground of plasma emitting device 150
154 cathode of plasma emitting device 150
156 plurality of nozzles of plasma emitting device 150
158 shell of plasma emitting device 150
159 base of shell 158 of plasma emitting device 150
160 anode of plasma emitting device 150

### Specific Configuration of Each Clamp Bracket 133 of Plasma Emitting Device 30

162 ring of each clamp bracket of plurality of clamp brackets 133 of plasma emitting device 30 for encircling associated pipe of plurality of pipes 124 of plasma emitting device 120
164 open portion of ring 162 of each clamp bracket of plurality of clamp brackets 133 of plasma emitting device 30
166 pair of opposing ends defining open portion 164 of ring 162 of each clamp bracket of plurality of clamp brackets 133 of plasma emitting device 30
168 pair of tabs of each clamp bracket of plurality of clamp brackets 133 of plasma emitting device 30
170 pair of through bores of pair of tabs 168 of each clamp bracket of plurality of clamp brackets 133 of plasma emitting device 30, respectively
172 bolt of each clamp bracket of plurality of clamp brackets 133 of plasma emitting device 30
174 head of bolt 172 of each clamp bracket of plurality of clamp brackets 133 of plasma emitting device 30
176 shaft of bolt 172 of each clamp bracket of plurality of clamp brackets 133 of plasma emitting device 30
178 free end of shaft 176 of bolt 172 of each clamp bracket of plurality of clamp brackets 133 of plasma emitting device 30
180 wingnut of each clamp bracket of plurality of clamp brackets 133 of plasma emitting device 30

### DETAILED DESCRIPTION OF THE PREFERRED EMBODIMENTS

### Introductory

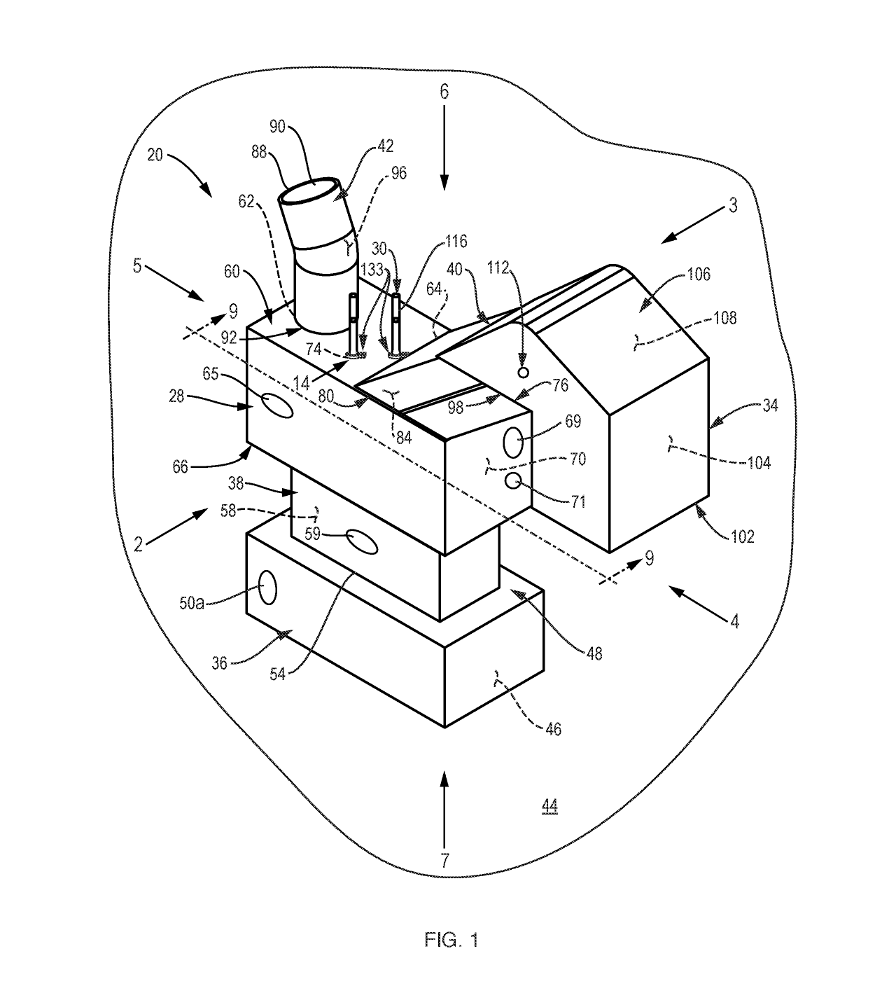

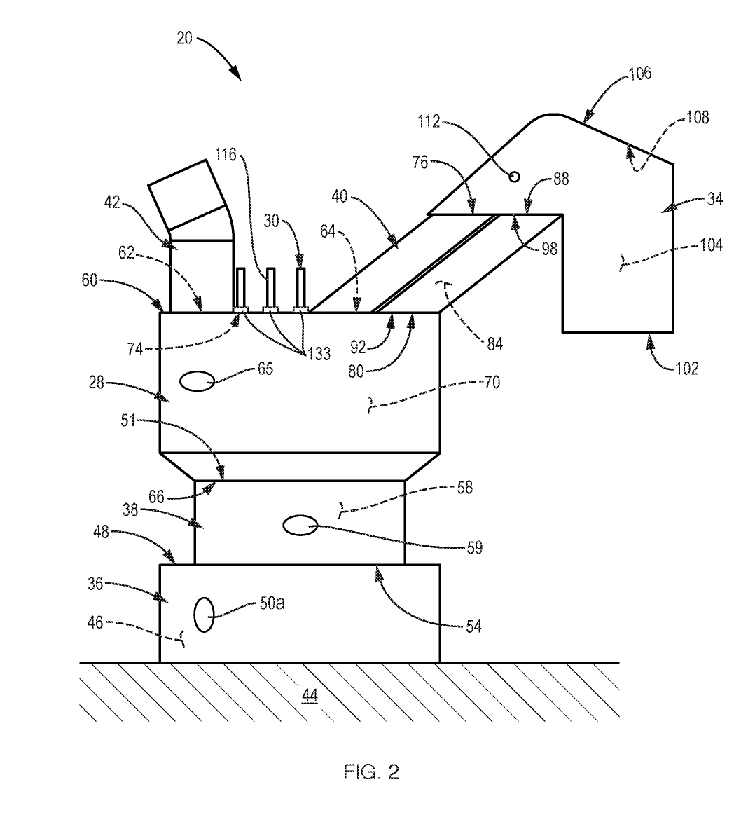

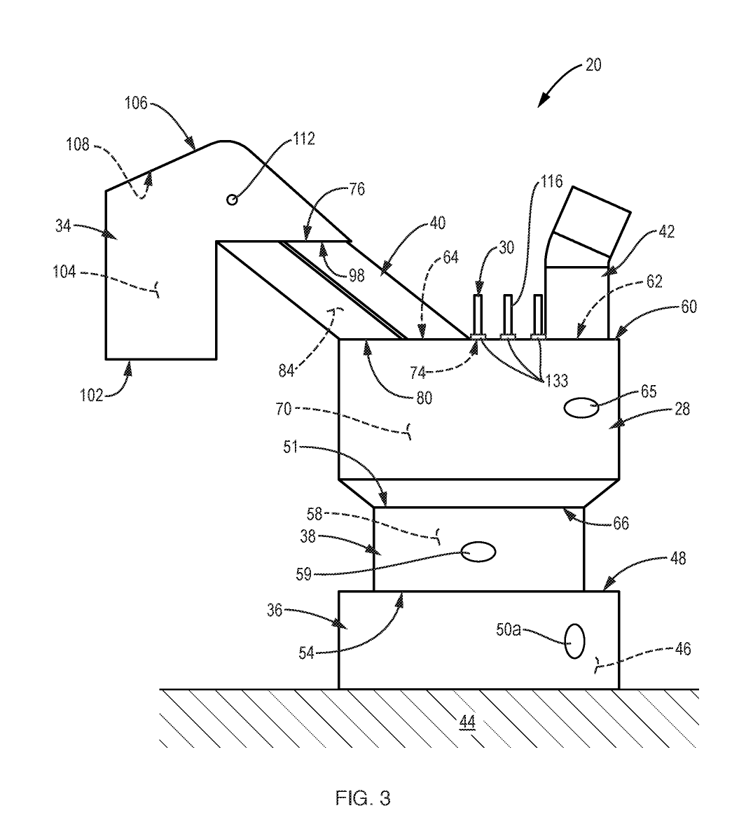

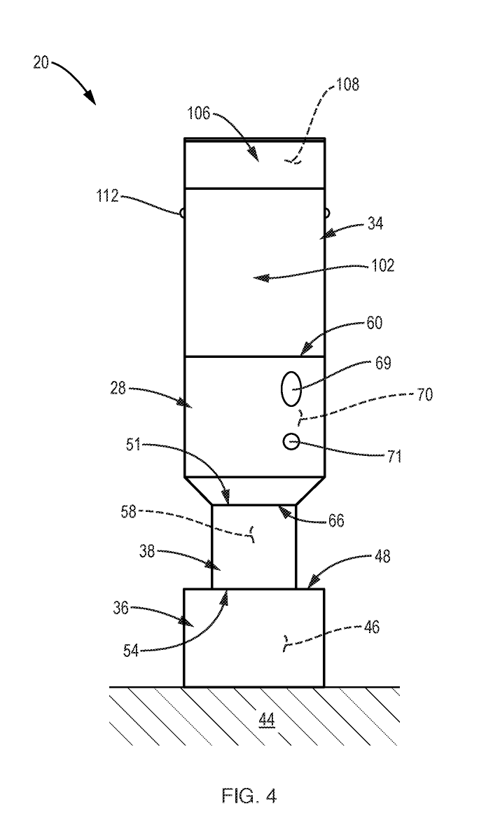

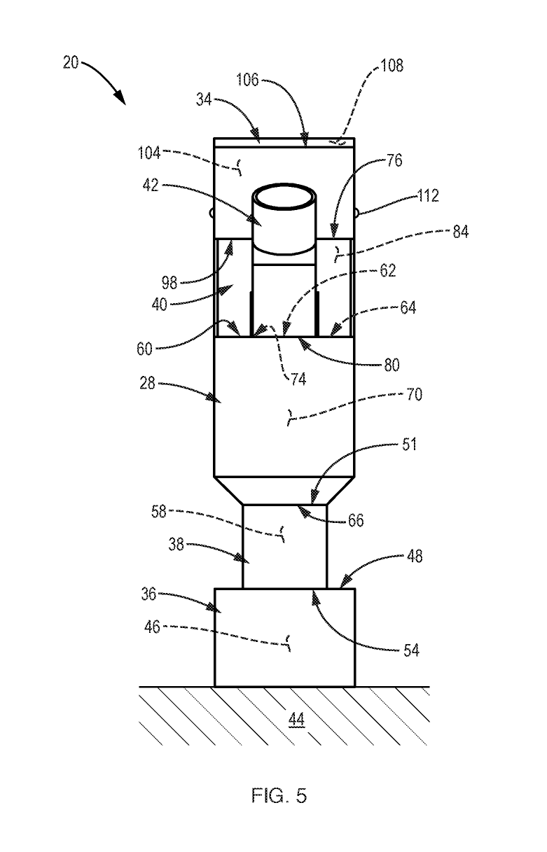

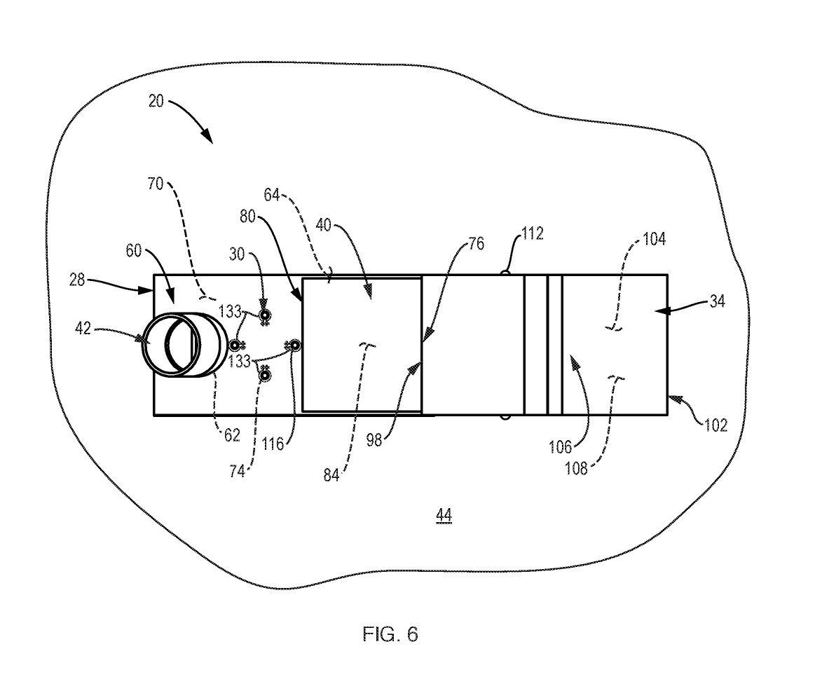

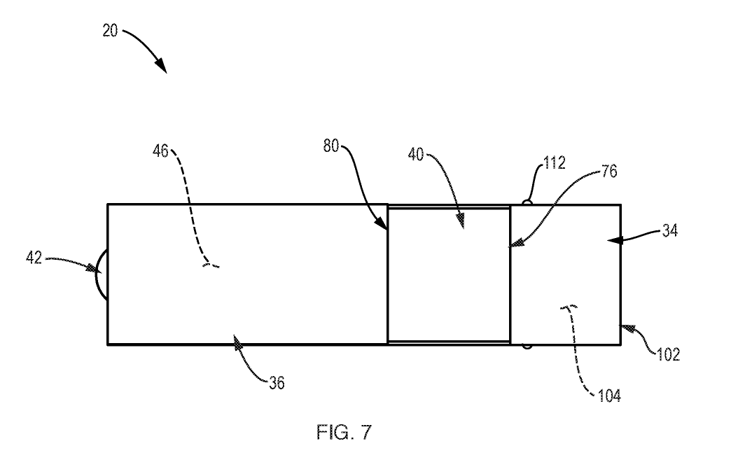

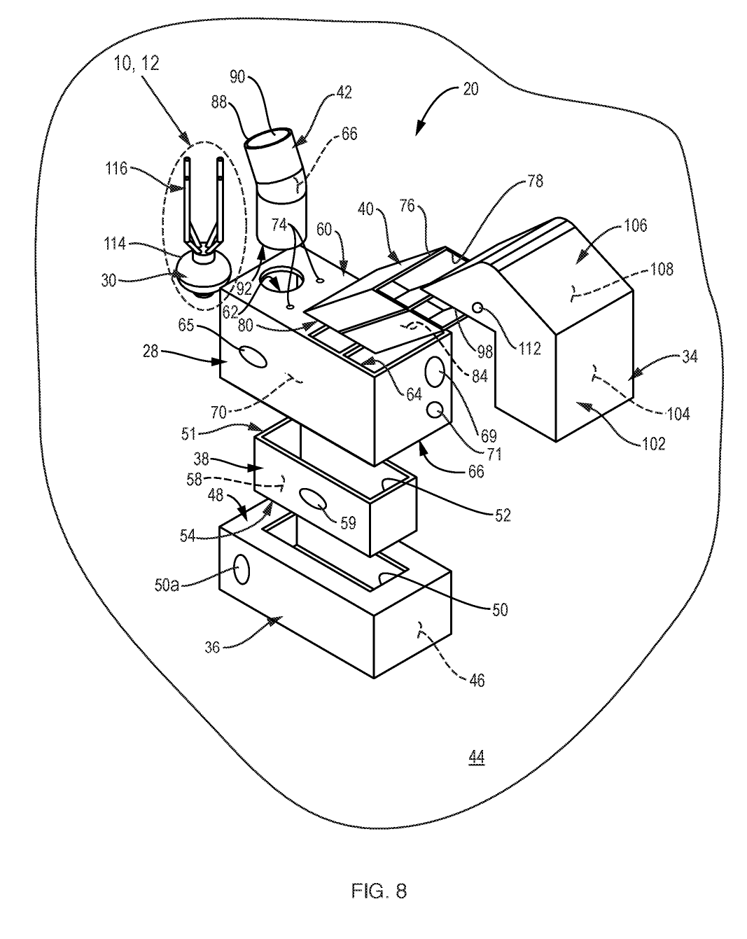

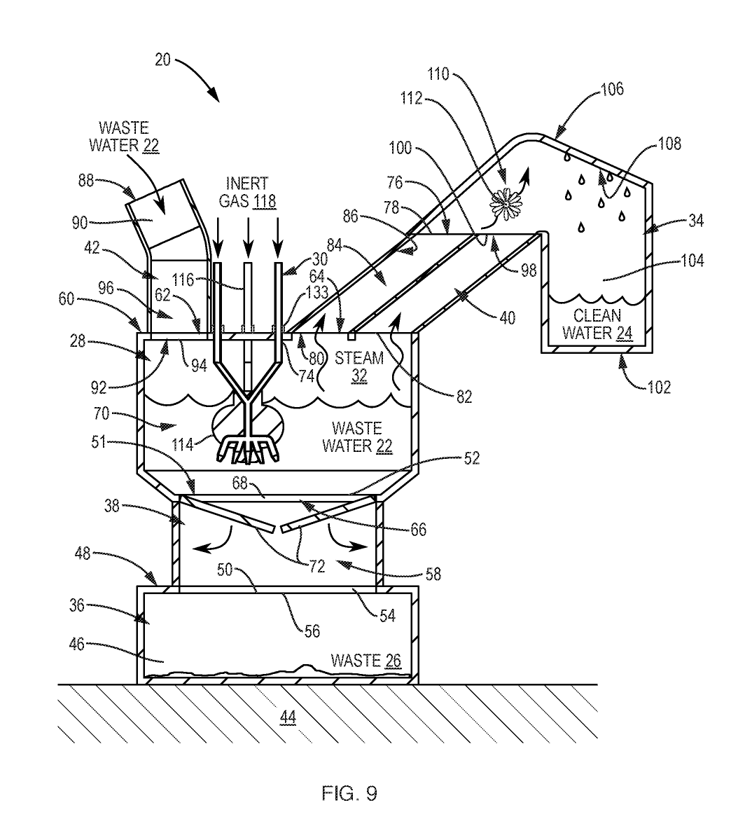

Referring now to the figures, in which like numerals indicate like parts, and particularly to FIGS. 1 to 9, the plasma gas water ionization purification system of the embodiments of the present invention is shown generally at 20 for purifying waste water 22 into clean water 24 by removing inert waste solids 26 from the waste water 22.

The term “waste water” refers to any water that has been adversely affected in quality by pollutants, waste, erosion, etc. Waste water may include, but is not limited to, saltwater, sewage, runoff, or water that has been contaminated by pollutants, such as, oil.

### Overall Configuration of the Plasma Gas Water Ionization Purification System 20

The plasma gas water ionization purification system 20 requires little maintenance and oversight because a majority of its process is automated, and also will not require any harmful chemicals to operate.

The plasma gas water ionization purification system 20 comprises an ionization chamber 28 and a plasma emitting device 30. The ionization chamber 28 is for receiving the waste water 22. The plasma emitting device 30 is operatively connected to the ionization chamber 28 and is for generating a stream of plasma to heat the waste water 22 in the ionization chamber 28 to generate purified steam 32 from the waste water 22, thereby resulting in separation of the purified steam 32 from the inert waste solids 26 in the waste water 22, with the purified steam 32 then being condensed into liquid form forming the clean water 24, which is collected for later use.

The plasma gas water ionization purification system 20 further comprises a collection chamber 34. The collection chamber 34 is in fluid communication with the ionization chamber 28 and is for condensing the purified steam 32 into the clean water 24 and for collecting the clean water 24.

The plasma gas water ionization purification system 20 further comprises a waste chamber 36. The waste chamber 36 is in communication with the ionization chamber 28 and is for collecting the inert waste solids 26 removed from the waste water 22.

The plasma gas water ionization purification system 20 further comprises a waste conduit 38. The waste conduit 38 connects the ionization chamber 28 to the waste chamber 36 and is for communicating the inert waste solids 26 in the ionization chamber 28 into the waste chamber 36.

The plasma gas water ionization purification system 20 further comprises a vapor conduit 40. The vapor conduit 40 connects the ionization chamber 28 to the collection chamber 34 and is for fluidly communicating the purified steam 32 in the ionization chamber 28 to the collection chamber 34.

The plasma gas water ionization purification system 20 further comprises an input conduit 42. The input conduit 42 connects to the ionization chamber 28 and is for fluidly directing the waste water 22 into the ionization chamber 28.

### Specific Configuration of the Waste Chamber 36

The waste chamber 36 is covered with a non-flammable and heat-resistant insulation 43, is for resting on a support surface 44, is generally parallelepiped-shaped, is horizontally oriented, and has a hollow interior 46, a top 48 with an opening 50, and a hatch 50a. The opening 50 of the top 48 of the waste chamber 36 communicates with the hollow interior 46 of the waste chamber 36. The waste chamber 36 is replaceable for cleaning and disposing of the inert waste solids 26 accumulated therein.

### Specific Configuration of the Waste Conduit 38

The waste conduit 38 is generally parallelepiped-shaped, is horizontally oriented, is tubular, and has a top 51 with an opening 52, a bottom 54 with an opening 56, is covered with non-flammable and heat-resistant insulation 57, and further has a hollow interior 58 and a maintenance hatch 59. The opening 52 of the top 51 of the waste conduit 38 and the opening 56 of the bottom 54 of the waste conduit 38 communicate with each other and with the hollow interior 58 of the waste conduit 38.

The waste conduit 38 is disposed vertically upwardly from the waste chamber 36, with the bottom 54 of the waste conduit 38 sealingly and replaceably attached to the top 48 of the waste chamber 36, and with the opening 56 of the bottom 54 of the waste conduit 38 communicating with the opening 50 of the top 48 of the waste chamber 36 for allowing the inert waste solids 26 in the waste conduit 38 to be directed to the waste chamber 36 via gravity.

### Specific Configuration of the Ionization Chamber 28

The ionization chamber 28 is generally parallelepiped-shaped, is covered with non-flammable and heat-resistant insulation 59a, is horizontally oriented, and has a top 60 with an input opening 62 and a vapor opening 64, a view portal 65, a bottom 66 with a waste opening 68, a maintenance hatch 69, a hollow interior 70, and a drain plug 71. The input opening 62 of the top 60 of the ionization chamber 28, the vapor opening 64 of the top 60 of the ionization chamber 28, and the waste opening 68 of the bottom 66 of the ionization chamber 28 communicate with each other and with the hollow interior 70 of the ionization chamber 28.

The input opening 62 of the top 60 of the ionization chamber 28 and the vapor opening 64 of the top 60 of the ionization chamber 28 are disposed at opposite ends of the top 60 of the ionization chamber 28.

The ionization chamber 28 is disposed vertically upwardly from the waste conduit 38, with the bottom 66 of the ionization chamber 28 sealingly and replaceably attached to the top 51 of the waste conduit 38, and with the waste opening 68 of the bottom 66 of the ionization chamber 28 selectively communicating with the opening 52 of the top 51 of the waste conduit 36 by trap doors 72 on the bottom 66 of the ionization chamber 28. The trap doors 72 on the bottom 66 of the ionization chamber 28 are for selectively allowing the inert waste solids 26 in the ionization chamber 28 to be directed into the waste conduit 38 and then into the waste chamber 36 via gravity.

The trap doors 72 on the bottom 66 of the ionization chamber 28 include a pair of hinged trap doors that swing downward to release the inert waste solids 26 in the ionization chamber 28. During purification phase, the trap doors 72 on the bottom 66 of the ionization chamber 28 remain sealed shut. Once the waste water 22 has been treated and converted to the clean water 24, the trap doors 72 on the bottom 66 of the ionization chamber 28 open to send the inert waste solids 26 down through the waste conduit 40 and into the waste chamber 34 via gravitation force.

The top 60 of the ionization chamber 28 further has a plurality of plasma device openings 74. The plurality of plasma device openings 74 of the top 60 of the ionization chamber 28 are circular-shaped.

### Specific Configuration of the Vapor Conduit 40

The vapor conduit 40 is generally parallelepiped-shaped, is tubular, and has a top 76 with an opening 78, a bottom 80 with an opening 82, a hollow interior 84, and walls 86. The opening 78 of the top 76 of the vapor conduit 40 and the opening 82 of the bottom 80 of the vapor conduit 40 communicate with each other and with the hollow interior 84 of the vapor conduit 40.

The vapor conduit 40 is disposed upwardly from, and at an outward angle with, the ionization chamber 28, with the bottom 80 of the vapor conduit 40 sealingly and replaceably attached to the top 60 of the ionization chamber 28, and with the opening 82 of the bottom 80 of the vapor conduit 40 communicating with the vapor opening 64 of the top 60 of the ionization chamber 28 for allowing the purified steam 32 coming from the ionization chamber 28 to be directed into the collection chamber 34 and be condensed into the clean water 24.

The vapor conduit 40, in the alternative, is disposed vertically upward from the ionization chamber 28 for maximizing condensation of the purified steam 32 along the walls 86 of the vapor conduit 40.

### Specific Configuration of the Input Conduit 42

The input conduit 42 is tubular, and has a top 88 with an opening 90, a bottom 92 with an opening 94, and a hollow interior 96. The opening 90 of the top 88 of the input conduit 42 and the opening 94 of the bottom 92 of the input conduit 42 communicate with each other and with the hollow interior 96 of the input conduit 42.

The input conduit 42 is disposed upwardly, and partially angularly, from the ionization chamber 28, with the bottom 92 of the input conduit 42 sealingly and replaceably attached to the top 60 of the ionization chamber 28, and with the opening 94 of the bottom 92 of the input conduit 42 communicating with the input opening 62 of the top 60 of the ionization chamber 28 for allowing the waste water 22 to enter the top 88 of the input conduit 42, flow down the input conduit 42, and end up in the ionization chamber 28.

### Specific Configuration of the Collection Chamber 34

The collection chamber 34 is substantially inverted L-shaped, is tubular, and has an input end 98 with an opening 100, a collection end 102, a hollow interior 104, and a ceiling 106 with an inner surface 108. The opening 100 of the input end 98 of the collection chamber 34 communicates with the hollow interior 104 of the collection chamber 34.

The collection chamber 34 is disposed upwardly and forwardly from the top 76 of the vapor conduit 40, with the input end 98 of the collection chamber 34 sealingly and replaceably attached to the top 76 of the vapor conduit 40, and with the opening 100 of the input end 98 of the collection chamber 34 communicating with the opening 78 of the top 76 of the vapor conduit 40 for allowing the purified steam 32 traveling through the vapor conduit 40 from the ionization chamber 28 to be directed into the collection chamber 34 and be condensed into the clean water 24.

The ceiling 106 of the collection chamber 34 is angled forwardly downwardly for facilitating the clean water 24 that was just condensed to slide down along the inner surface 108 of the ceiling 106 and into the collection chamber 34 for collection.

The collection chamber 34 contains a fan 110 and an axle 112. The fan 110 of the collection chamber 34 is operatively connected to the axle 112 of the collection chamber 34. The axle 112 of the collection chamber 34 extends laterally across the collection chamber 34 for allowing the fan 110 of the collection chamber 34 on the axle 112 of the collection chamber 34 to expeditiously move the purified steam 32 being condensed 24 through the collection chamber 34, while adding an element of coolness for further facilitating condensing the purified steam 32.

Steam turns the fan 110 of the collection chamber 34 that is hooked up to a generator to generate electricity when the steam turns the fan 110 of the collection chamber 34.

### Overall Configuration of the Plasma Emitting Device 30

The plasma emitting device 30 comprises a head 114 and a tail 116. The head 114 of the plasma emitting device 30 is disposed in the ionization chamber 28 and is for heating the waste water 22. The tail 116 of the plasma emitting device 30 extends upwardly from the head 114 of the plasma emitting device 30, through the plurality of plasma device openings 74 of the top 60 of the ionization chamber 28, respectively, and is for receiving an inert gas 118 and feeding the inert gas 118 to the head 114 of the plasma emitting device 30.

The plasma emitting device 30 can be a plurality/multiplicity of plasma emitting devices that can be mounted beyond a signal device design for expanded and purification volumes.

### Specific Configuration of a First Embodiment of the Plasma Emitting Device 120

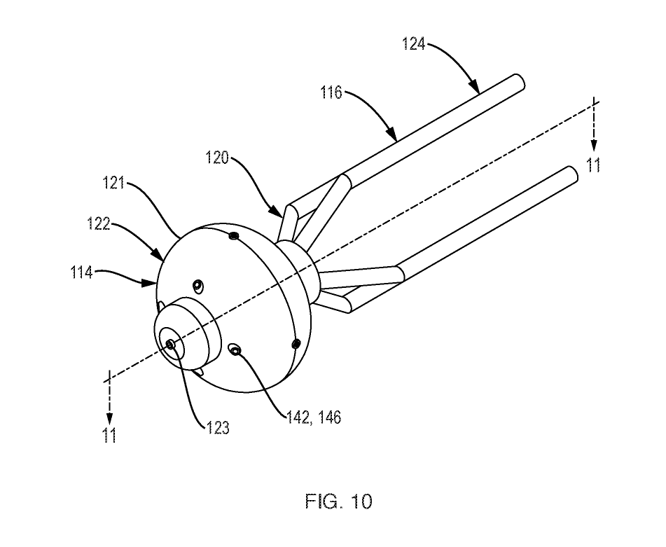

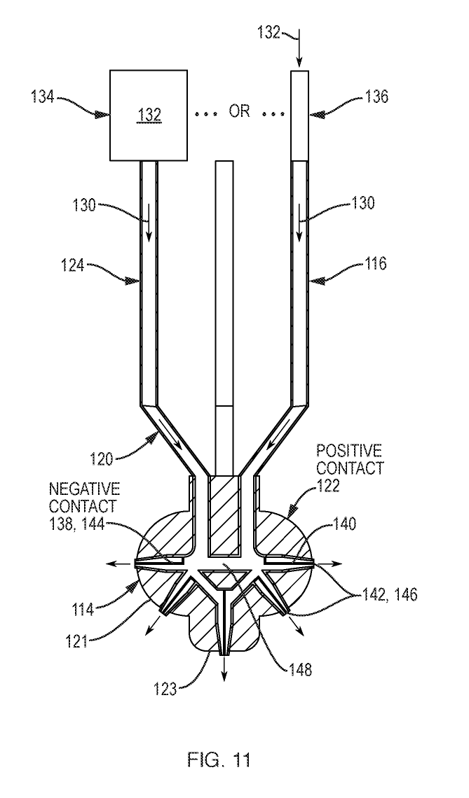

The specific configuration of a first embodiment of the plasma emitting device 120 can best be seen in FIGS. 10 and 11, and as such, will be discussed with reference thereto.

The plasma emitting device 120 comprises an ignition device 122 and a plurality of pipes 124. The ignition device 122 of the plasma emitting device 120 is the head 114 of the plasma emitting device 120 and has a base 123. The plurality of pipes 124 of the plasma emitting device 120 are the tail 116 of the plasma emitting device 120 and are for interfacing with the inert gas 130 stored as a gas source 132.

The plasma emitting device 30 further comprises a plurality of clamp brackets 133. The plurality of clamp brackets 133 of the plasma emitting device 30 encircle the plurality of pipes 124 of the plasma emitting device 120, respectively, and rest on the top 60 of the ionization chamber 28. The plurality of pipes 124 of the plasma emitting device 120 move up and down through the plurality of plasma device openings 74 of the top 60 of the ionization chamber 28, respectively, for desired height placement adjustment thereof, and are selectively maintained at the desired height placement adjustment by the plurality of clamp brackets 133 of the plasma emitting device 30.

The gas source 132 of the plasma emitting device 120 include one of a storage tank 134 and a direct line 136 for supplying and forcing the inert gas 130 into the plurality of pipes 124 of the plasma emitting device 120.

The plurality of pipes 124 of the plasma emitting device 120 are cylindrical tubes for connecting the gas source 132 to the ignition device 122 of the plasma emitting device 120 and for injecting the inert gas 130 into the ignition device 122 of the plasma emitting device 120 for ionization and thus plasma ignition.

The ignition device 122 of the plasma emitting device 120 comprises a plurality of electrode torches 138, a plurality of gas channels 140, and a plurality of nozzles 142, and is for producing a stream of plasma via ionization of the inert gas 130.

The plurality of electrode torches 138 of the ignition device 122 of the plasma emitting device 120 and the plurality of nozzles 142 of the ignition device 122 of the plasma emitting device 120 act as cathodes 144 and anodes 146, respectively.

The plurality of gas channels 140 of the ignition device 122 of the plasma emitting device 120 are arranged around the plurality of electrode torches 138 of the ignition device 122 of the plasma emitting device 120, respectively, and connect to, and communicate with, the plurality of pipes 124 of the plasma emitting device 120, respectively, for receiving the inert gas 130.

The plurality of nozzles 142 of the ignition device 122 of the plasma emitting device 120 are arranged just beyond the plurality of electrode torches 138 of the ignition device 122 of the plasma emitting device 120, respectively, for maintaining an electric arc between the plurality of electrode torches 138 of the ignition device 122 of the plasma emitting device 120.

The inert gas 130 is injected into the plurality of gas channels 140 of the ignition device 122 of the plasma emitting device 120 and out of the plurality of nozzles 142 of the ignition device 122 of the plasma emitting device 120, receiving energy from the electric arc of the plurality of electrode torches 138 of the ignition device 122 of the plasma emitting device 120 and thus generating the stream of plasma.

The plurality of gas channels 140 of the ignition device 122 of the plasma emitting device 120 form a circular gas pipe 148 within the plasma emitting device 120 and is oriented parallel to the base 123 of the ignition device 122 of the plasma emitting device 120.

The plurality of gas channels 140 of the ignition device 122 of the plasma emitting device 120 extend from the circular gas pipe 148 of the plasma emitting device 120 and out of the shell 121 of ignition device 122 of the plasma emitting device 120.

The plasma gas water ionization purification system 20 is not limited to any number of the plurality of pipes 124 of the plasma emitting device 120, the plurality of electrode torches 138 of the ignition device 122 of the plasma emitting device 120, the plurality of gas channels 140 of the ignition device 122 of the plasma emitting device 120, and the plurality of nozzles 142 of the ignition device 122 of the plasma emitting device 120, as a greater number of the plurality of electrode torches 138 of the ignition device 122 of the plasma emitting device 120, the plurality of gas channels 140 of the ignition device 122 of the plasma emitting device 120, and the plurality of nozzles 142 of the ignition device 122 of the plasma emitting device 120 may be incorporated for increasing the stream of plasma generated by the plasma emitting device 120 via ionization of the inert gas 130 when there is a need for an increased amount of the inert gas 130 to ignite and maintain the stream of plasma.

### Specific Configuration of a Second Embodiment of the Plasma Emitting Device 150

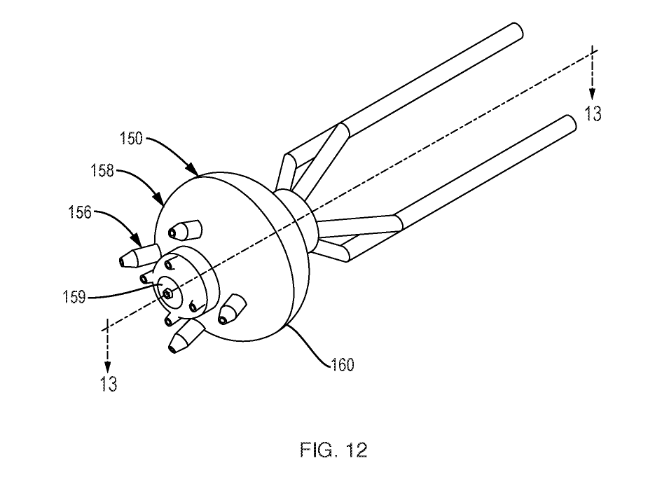

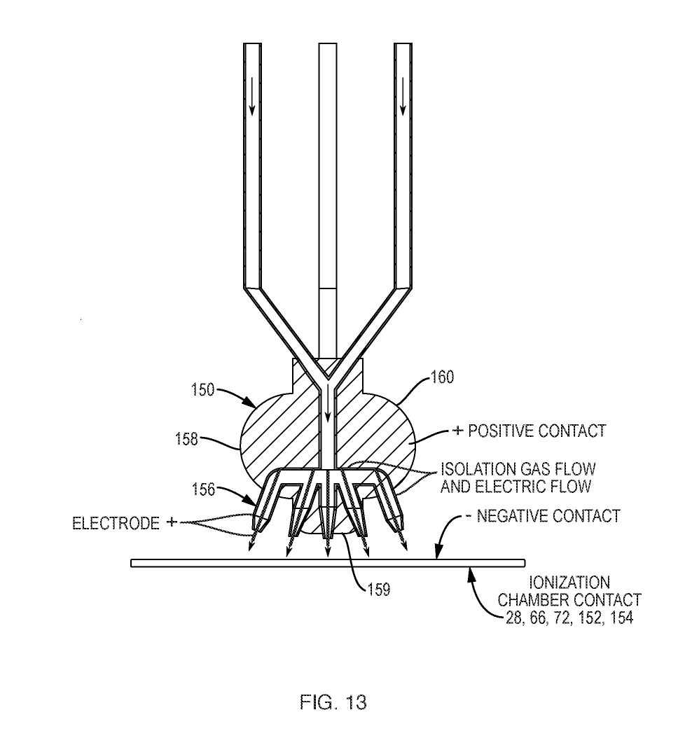

The specific configuration of a second embodiment of the plasma emitting device 150 can best be seen in FIGS. 12 and 13, and as such, will be discussed with reference thereto.

The plasma emitting device 150 functions without electrode torches.

The plasma emitting device 150 utilizes the ionization chamber 28 as the ground 152, alternatively known, as the cathode 154, and includes a plurality of nozzles 156 and a shell 158 with a base 159, and utilizing the shell 158 of the plasma emitting device 150 as an anode 160.

An electric arc is maintained between the plurality of nozzles 156 of the plasma emitting device 150 and the trap doors 72 on the bottom 66 of the ionization chamber 28 for generating the stream of plasma.

The plurality of nozzles 156 of the plasma emitting device 150 extend further out of the shell 158 of the plasma emitting device 150 and are oriented toward the base 159 of the shell 158 of the plasma emitting device 150.

### Specific Configuration of Each Clamp Bracket 133 of the Plasma Emitting Device 30

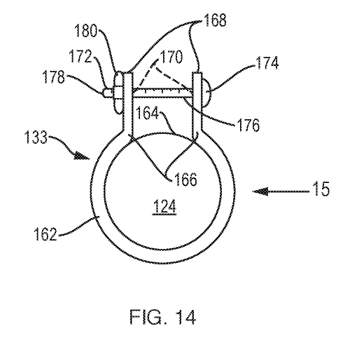

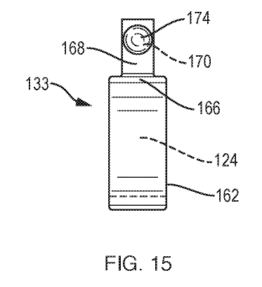

The specific configuration of each clamp bracket 133 of the plasma emitting device 30 can best be seen in FIGS. 14 and 15, and as such, will be discussed with reference thereto.

Each clamp bracket 133 of the plasma emitting device 30 comprises a ring 162. The ring 162 of each clamp bracket 133 of the plasma emitting device 30 encircles an associated pipe 124 of the plasma emitting device 120, and has an open portion 164 defined by a pair of opposing ends 166.

Each clamp bracket 133 of the plasma emitting device 30 further comprises a pair of tabs 168. The pair of tabs 168 of each clamp bracket 133 of the plasma emitting device 30 are parallel to each other and extend outwardly from the pair of opposing ends 166 of the open portion 164 of an associated clamp bracket 133 of the plasma emitting device 30, respectively.

The pair of tabs 168 of each clamp bracket 133 of the plasma emitting device 30 have a pair of through bores 170, respectively. The pair of through bores 170 of the pair of tabs 168 of each clamp bracket 133 of the plasma emitting device 30 are aligned with each other.

Each clamp bracket 133 of the plasma emitting device 30 further comprises a bolt 172 having a head 174 and a shaft 176 with a free end 178. The bolt 172 of each clamp bracket 133 of the plasma emitting device 30 extends through the pair of through bores 170 of the pair of tabs 168 of an associated clamp bracket 133 of the plasma emitting device 30, with the head 174 of the bolt 172 of the associated clamp bracket 133 of the plasma emitting device 30 resting against one tab 168 of the associated clamp bracket 133 of the plasma emitting device 30, and with the shaft 176 of the bolt 172 of the associated clamp bracket 133 of the plasma emitting device 30 extending out from the through bore 170 of the other tab 168 of the associated clamp bracket 133 of the plasma emitting device 30.

Each clamp bracket 133 of the plasma emitting device 30 further comprises a wingnut 180. The wingnut 180 of each clamp bracket 133 of the plasma emitting device 30 threads onto the free end 178 of the shaft 176 of the bolt 172 of an associated clamp bracket 133 of the plasma emitting device 30, and in doing so, tightens the ring 162 of the associated clamp bracket 133 of the plasma emitting device 30 around an associated pipe 124 of the plasma emitting device 120 to maintain the associated pipe 124 of the plasma emitting device 120 at the desired height placement adjustment.

### IMPRESSIONS

It will be understood that each of the elements described above or two or more together may also find a useful application in other types of constructions differing from the types described above.

While the embodiments of the present invention have been illustrated and described as embodied in a plasma gas water ionization purification system, nevertheless, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A plasma gas water ionization purification system for purifying waste water into clean water by removing inert waste solids from the waste water, comprising:
a) an ionization chamber; and
b) a plasma emitting device;
wherein said ionization chamber is for receiving the waste water;
wherein said plasma emitting device is operatively connected to said ionization chamber; and
wherein said plasma emitting device is for generating a stream of plasma to heat the waste water in said ionization chamber to generate purified steam from the waste water, thereby resulting in separation of the purified steam from the inert waste solids in the waste water, with the purified steam then being condensed into liquid form forming the clean water, which is collected for later use.

2. The plasma gas water ionization purification system of claim 1, further comprising a collection chamber;
wherein said collection chamber is in fluid communication with said ionization chamber;
wherein said collection chamber is for condensing the purified steam into the clean water; and
wherein said collection chamber is for collecting the clean water.

3. The plasma gas water ionization purification system of claim 2, further comprising a waste chamber;
wherein said waste chamber is in communication with said ionization chamber; and
wherein said waste chamber is for collecting the inert waste solids removed from the waste water.

4. The plasma gas water ionization purification system of claim 3, further comprising a waste conduit;
wherein said waste conduit connects said ionization chamber to said waste chamber; and
wherein said waste conduit is for communicating the inert waste solids in said ionization chamber to said waste chamber.

5. The plasma gas water ionization purification system of claim 4, further comprising a vapor conduit;
wherein said vapor conduit connects said ionization chamber to said collection chamber; and
wherein said vapor conduit is for fluidly communicating the purified steam in said ionization chamber to said collection chamber.

6. The plasma gas water ionization purification system of claim 5, further comprising an input conduit;
wherein said input conduit connects to said ionization chamber; and
wherein said input conduit is for fluidly directing the waste water into said ionization chamber.

7. The plasma gas water ionization purification system of claim 3, wherein said waste chamber is covered with a non-flammable and heat-resistant insulation;
wherein said waste chamber is for resting on a support surface;
wherein said waste chamber is generally parallelepiped-shaped; and
wherein said waste chamber is horizontally oriented.

8. The plasma gas water ionization purification system of claim 6, wherein said waste chamber has:
a) a hollow interior;
b) a top with an opening; and
c) a hatch;
wherein said opening of said top of said waste chamber communicates with said hollow interior of said waste chamber; and
wherein said waste chamber is replaceable for cleaning and disposing of the inert waste solids accumulated therein.

9. The plasma gas water ionization purification system of claim 4, wherein said waste conduit is generally parallelepiped-shaped;
wherein said waste conduit is horizontally oriented; and
wherein said waste conduit is tubular.

10. The plasma gas water ionization purification system of claim 4, wherein said waste conduit has a maintenance hatch; and
wherein said waste conduit is covered with non-flammable and heat-resistant insulation.

11. The plasma gas water ionization purification system of claim 8, wherein said waste conduit has:
a) a hollow interior;
b) a top with an opening; and
c) a bottom with an opening;
wherein said opening of said top of said waste conduit and said opening of said bottom of said waste conduit communicate with each other; and
wherein said opening of said top of said waste conduit and said opening of said bottom of said waste conduit communicate with said hollow interior of said waste conduit.

12. The plasma gas water ionization purification system of claim 11, wherein said waste conduit is disposed vertically upwardly from said waste chamber;
wherein said bottom of said waste conduit is sealingly and replaceably attached to said top of said waste chamber; and
wherein said opening of said bottom of said waste conduit communicates with said opening of said top of said waste chamber for allowing the inert waste solids in said waste conduit to be directed into said waste chamber via gravity.

13. The plasma gas water ionization purification system of claim 1, wherein said ionization chamber is generally parallelepiped-shaped;
wherein said ionization chamber is covered with non-flammable and heat-resistant insulation; and
wherein said ionization chamber is horizontally oriented.

14. The plasma gas water ionization purification system of claim 11, wherein said ionization chamber has:
a) a view portal;
b) a maintenance hatch;
c) a hollow interior; and
d) a drain plug.

15. The plasma gas water ionization purification system of claim 14, wherein said ionization chamber has:
a) a top with an input opening and a vapor opening; and
b) a bottom with a waste opening;
wherein said input opening of said top of said ionization chamber, said vapor opening of said top of said ionization chamber, and said waste opening of said bottom of said ionization chamber communicate with each other and with said hollow interior of said ionization chamber.

16. The plasma gas water ionization purification system of claim 15, wherein said input opening of said top of said ionization chamber and said vapor opening of said top of said ionization chamber are disposed at opposite ends of said top of said ionization chamber.

17. The plasma gas water ionization purification system of claim 15, wherein said ionization chamber is disposed vertically upwardly from said waste conduit;
wherein said bottom of said ionization chamber is sealingly and replaceably attached to said top of said waste conduit;
wherein said waste opening of said bottom of said ionization chamber selectively communicates with said opening of said top of said waste conduit by trap doors on said bottom of said ionization chamber; and
wherein said trap doors on said bottom of said ionization chamber are for selectively allowing the inert waste solids in said ionization chamber to be directed into said waste conduit and then into said waste chamber via gravity.

18. The plasma gas water ionization purification system of claim 17, wherein said trap doors on said bottom of said ionization chamber include a pair of hinged trap doors; and
wherein said pair of hinged trap doors of said bottom of said ionization chamber are for swinging downward to release the inert waste solids within said ionization chamber.

19. The plasma gas water ionization purification system of claim 17, wherein during purification said trap doors on said bottom of said ionization chamber remain sealed shut, and once the waste water has been treated and converted to the clean water, said trap doors on said bottom of said ionization chamber open to send the inert waste solids down through said waste conduit and into said waste chamber via gravitation force.

20. The plasma gas water ionization purification system of claim 15, wherein said top of said ionization chamber has a plurality of plasma device openings; and
wherein said plurality of plasma device openings of said top of said ionization chamber are circular-shaped.

21. The plasma gas water ionization purification system of claim 15, wherein said vapor conduit is generally parallelepiped-shaped;
wherein said vapor conduit is tubular;
wherein said vapor conduit has:
a) a top with an opening;
b) a bottom with an opening;
c) a hollow interior; and
d) walls;
wherein said opening of said top of said vapor conduit and said opening of said bottom of said vapor conduit communicate with each other and with said hollow interior of said vapor conduit.

22. The plasma gas water ionization purification system of claim 21, wherein said vapor conduit is disposed upwardly from, and at an outward angle with, said ionization chamber;
wherein said bottom of said vapor conduit is sealingly and replaceably attached to said top of said ionization chamber; and
wherein said opening of said bottom of said vapor conduit communicates with said vapor opening of said top of said ionization chamber for allowing the purified steam coming from said ionization chamber to be directed into said collection chamber and be condensed into the clean water.

23. The plasma gas water ionization purification system of claim 21, wherein said vapor conduit is disposed vertically upward from said ionization chamber for maximizing condensation of the purified steam along said walls of said vapor conduit.

24. The plasma gas water ionization purification system of claim 15, wherein said input conduit is tubular;
wherein said input conduit has:
a) a top with an opening;
b) a bottom with an opening; and
c) a hollow interior;
wherein said opening of said top of said input conduit and said opening of said bottom of said input conduit communicate with each other and with said hollow interior of said input conduit.

25. The plasma gas water ionization purification system of claim 24, wherein said input conduit is disposed upwardly, and partially angularly, from said ionization chamber;
wherein said bottom of said input conduit is sealingly and replaceably attached to said top of said ionization chamber; and
wherein said opening of said bottom of said input conduit communicates with said input opening of said top of said ionization chamber for allowing the waste water to enter said top of said input conduit, flow down said input conduit, and end up in said ionization chamber.

26. The plasma gas water ionization purification system of claim 21, wherein said collection chamber is substantially inverted L-shaped;
wherein said collection chamber is tubular;
wherein said collection chamber has:
a) an input end with an opening;
b) a collection end;
c) a hollow interior; and
d) a ceiling with an inner surface;
wherein said opening of said input end of said collection chamber communicates with said hollow interior of said collection chamber.

27. The plasma gas water ionization purification system of claim 26, wherein said collection chamber is disposed upwardly and forwardly from said top of said vapor conduit;
wherein said input end of said collection chamber is sealingly and replaceably attached to said top of said vapor conduit; and
wherein said opening of said input end of said collection chamber communicates with said opening of said top of said vapor conduit for allowing the purified steam traveling through said vapor conduit from said ionization chamber to be directed into said collection chamber and be condensed into the clean water.

28. The plasma gas water ionization purification system of claim 26, wherein said ceiling of said collection chamber is angled forwardly downwardly for facilitating the clean water that was just condensed to slide down along said inner surface of said ceiling and into said collection chamber for collection.

29. The plasma gas water ionization purification system of claim 2, wherein said collection chamber contains:
a) a fan; and
b) an axle;
wherein said fan of said collection chamber is operatively connected to said axle of said collection chamber; and
wherein said axle of said collection chamber extends laterally across said collection chamber for allowing said fan of said collection chamber on said axle of said collection chamber to expeditiously move the clean water being condensed through said collection chamber, while adding an element of coolness for further facilitating condensing of the clean water.

30. The plasma gas water ionization purification system of claim 20, wherein said plasma emitting device comprises:
a) a head; and
b) a tail;
wherein said head of said plasma emitting device is disposed in said ionization chamber;
wherein said head of said plasma emitting device is for heating the waste water;
wherein said tail of said plasma emitting device extends upwardly from said head of said plasma emitting device, and through said plurality of plasma device openings of said top of said ionization chamber, respectively; and
wherein said tail of said plasma emitting device is for receiving an inert gas and feeding the inert gas to said head of said plasma emitting device.

31. The plasma gas water ionization purification system of claim 30, wherein said plasma emitting device comprises:
a) an ignition device; and
b) a plurality of pipes;
wherein said ignition device of said plasma emitting device is said head of said plasma emitting device;
wherein said ignition device of said plasma emitting device has a base;
wherein said plurality of pipes of said plasma emitting device are said tail of said plasma emitting device; and
wherein said plurality of pipes of said plasma emitting device are for interfacing with the inert gas stored as a gas source.

32. The plasma gas water ionization purification system of claim 31, wherein said gas source of said plasma emitting device includes a storage tank.

33. The plasma gas water ionization purification system of claim 31, wherein said gas source of said plasma emitting device includes a direct line for supplying and forcing the inert gas into said plurality of pipes of said plasma emitting device.

34. The plasma gas water ionization purification system of claim 31, wherein said plurality of pipes of said plasma emitting device are cylindrical tubes for connecting said gas source to said ignition device of said plasma emitting device; and
wherein said plurality of pipes of said plasma emitting device are for injecting the inert gas into said ignition device of said plasma emitting device for ionization and thus plasma ignition.

35. The plasma gas water ionization purification system of claim 31, wherein said ignition device of said plasma emitting device comprises:
a) a plurality of electrode torches;
b) a plurality of gas channels; and
c) a plurality of nozzles;
wherein said ignition device of said plasma emitting device is for producing a stream of plasma via ionization of the inert gas.

36. The plasma gas water ionization purification system of claim 35, wherein said plurality of electrode torches of said ignition device of said plasma emitting device and said plurality of nozzles of said ignition device of said plasma emitting device act as cathodes and anodes, respectively.

37. The plasma gas water ionization purification system of claim 35, wherein said plurality of gas channels of said ignition device of said plasma emitting device are arranged around said plurality of electrode torches of said ignition device of said plasma emitting device, respectively; and
wherein said plurality of gas channels of said ignition device of said plasma emitting device connect to said plurality of pipes of said plasma emitting device, respectively, for receiving the inert gas.

38. The plasma gas water ionization purification system of claim 35, wherein said plurality of nozzles of said ignition device of said plasma emitting device are arranged just beyond said plurality of electrode torches of said ignition device of said plasma emitting device, respectively, for maintaining an electric arc between said plurality of electrode torches of said ignition device of said plasma emitting device.

39. The plasma gas water ionization purification system of claim 38, wherein the inert gas is for injecting into said plurality of gas channels of said ignition device of said plasma emitting device and out of said plurality of nozzles of said ignition device of said plasma emitting device, receiving energy from said electric arc of said plurality of electrode torches of said ignition device of said plasma emitting device and thus generating said stream of plasma.

40. The plasma gas water ionization purification system of claim 35, wherein said plurality of gas channels of said ignition device of said plasma emitting device form a circular gas pipe within said plasma emitting device; and
wherein said circular gas pipe of said plasma emitting device is oriented parallel to said base of said ignition device of said plasma emitting device.

41. The plasma gas water ionization purification system of claim 40, wherein said plurality of gas channels of said ignition device of said plasma emitting device extend from said circular gas pipe of said plasma emitting device and out of a shell of said ignition device of said plasma emitting device.

42. The plasma gas water ionization purification system of claim 17, wherein said plasma emitting device functions without electrode torches.

43. The plasma gas water ionization purification system of claim 42, wherein said plasma emitting device includes:
a) a plurality of nozzles; and
b) a shell with a base;
wherein said plasma emitting device utilizes said ionization chamber as a ground/cathode; and
wherein said plasma emitting device utilizes said shell of said plasma emitting device as an anode.

44. The plasma gas water ionization purification system of claim 43, wherein an electric arc is maintained between said plurality of nozzles of said plasma emitting device and said trap doors on said bottom of said ionization chamber for generating the stream of plasma.

45. The plasma gas water ionization purification system of claim 43, wherein said plurality of nozzles of said plasma emitting device extend further out of said shell of said plasma emitting device and are oriented toward said base of said shell of said plasma emitting device.

46. The plasma gas water ionization purification system of claim 31, wherein said plasma emitting device comprises a plurality of clamp brackets;
wherein said plurality of clamp brackets of said plasma emitting device encircle said plurality of pipes of said plasma emitting device, respectively;
wherein said plurality of clamp brackets of said plasma emitting device rest on said top of said ionization chamber; and
wherein said plurality of pipes of said plasma emitting device move up and down through said plurality of plasma device openings of said top of said ionization chamber, respectively, for desired height placement adjustment thereof, and are selectively maintained at the desired height placement adjustment by said plurality of clamp brackets of said plasma emitting device.

47. The plasma gas water ionization purification system of claim 46, wherein each clamp bracket of said plasma emitting device comprises a ring; and
wherein said ring of each clamp bracket of said plasma emitting device encircles an associated pipe of said plasma emitting device.

48. The plasma gas water ionization purification system of claim 47, wherein said ring of each clamp bracket of said plasma emitting device has an open portion defined by a pair of opposing ends.

49. The plasma gas water ionization purification system of claim 48, wherein each clamp bracket of said plasma emitting device comprises a pair of tabs;
wherein said pair of tabs of each clamp bracket of said plasma emitting device are parallel to each other; and
wherein said pair of tabs of each clamp bracket of said plasma emitting device extend outwardly from said pair of opposing ends of said open portion of an associated clamp bracket of said plasma emitting device, respectively.

50. The plasma gas water ionization purification system of claim 49, wherein said pair of tabs of each clamp bracket of said plasma emitting device have a pair of through bores, respectively; and
wherein said pair of through bores of said pair of tabs of each clamp bracket of said plasma emitting device are aligned with each other.

51. The plasma gas water ionization purification system of claim 50, wherein each clamp bracket of said plasma emitting device comprises a bolt having a head and a shaft with a free end; and
wherein said bolt of each clamp bracket of said plasma emitting device extends through said pair of through bores of said pair of tabs of an associated clamp bracket of said plasma emitting device.

52. The plasma gas water ionization purification system of claim 51, wherein said head of said bolt of each clamp bracket of said plasma emitting device rests against one tab of an associated clamp bracket of said plasma emitting device.

53. The plasma gas water ionization purification system of claim 51, wherein said shaft of said bolt of each clamp bracket of said plasma emitting device extends out from said through bore of the other tab of an associated clamp bracket of said plasma emitting device.

54. The plasma gas water ionization purification system of claim 51, wherein each clamp bracket of said plasma emitting device comprises a wingnut; and
wherein said wingnut of each clamp bracket of said plasma emitting device threads onto said free end of said shaft of said bolt of an associated clamp bracket of the plasma emitting device, and in doing so, tightens said ring of said associated clamp bracket of said plasma emitting device around an associated pipe of said plasma emitting device to maintain said associated pipe of said plasma emitting device at the desired height placement adjustment.

55. The plasma gas water ionization purification system of claim 29, wherein steam turns said fan that is hooked up to a generator to generate electricity when the steam turns said fan.
